(19) United States
(12) Patent Application Publication
(10) Pub. No.: US 2025/0046010 A1
(43) Pub. Date: Feb. 6, 2025

(54) METHOD AND SYSTEM FOR ESTIMATING 3D CAMERA POSE BASED ON 2D IMAGE FEATURES AND APPLICATION THEREOF

(71) Applicant: EDDA TECHNOLOGY, INC., PRINCETON, NJ (US)

(72) Inventors: Xiaotao Guo, Bronx, NY (US); Guo-Qing Wei, Plainsboro, NJ (US); Li Fan, Belle Mead, NJ (US); Xiaolan Zeng, Princeton, NJ (US); Jianzhong Qian, Princeton Junction, NJ (US)

(21) Appl. No.: 18/790,201

(22) Filed: Jul. 31, 2024

Related U.S. Application Data
(60) Provisional application No. 63/529,985, filed on Jul. 31, 2023.

(51) Int. Cl. G06T 15/20; G06T 7/11; G06T 7/70; G06T 17/00

(52) U.S. Cl. CPC G06T 15/205; G06T 7/11; G06T 7/70; G06T 17/00; G06T 2207/20081; G06T 2207/30004; G06T 2207/30244; G06T 2210/41

(57) ABSTRACT

Method and system for estimating 3D camera pose based on 2D features. 3D virtual camera poses are generated, each of which is used to determine a perspective to project a 3D model of a target organ to create a 2D image of the target organ. 2D features are extracted from each 2D image and paired with the corresponding 3D virtual camera pose to represent a mapping. A 2D feature-camera pose mapping model is obtained based on the pairs. Input 2D features extracted from a real-time 2D image of the target organ are used to map, via the 2D feature-camera pose mapping model, to a 3D pose estimate of a laparoscopic camera, which is then refined to derive an estimated 3D camera pose of the laparoscopic camera via differential rendering of the 3D model with respect to the 3D pose estimate.

### CROSS REFERENCE TO RELATED APPLICATIONS

The present application claims the benefit and priority of U.S. Provisional Patent Application No. 63/529,985, filed on Jul. 31, 2023, entitled “METHOD AND SYSTEM FOR ESTIMATING 3D CAMERA POSE BASED ON 2D IMAGE FEATURES AND APPLICATION IN A LAPAROSCOPIC PROCEDURE”, the contents of which are hereby incorporated by reference in its entirety.

The present application is related to International patent application Ser. No. ______ (Attorney Docket No. 140551.597694), filed on Jul. 31, 2024, entitled “METHOD AND SYSTEM FOR ESTIMATING 3D CAMERA POSE BASED ON 2D IMAGE FEATURES AND APPLICATION THEREOF”, the contents of which are hereby incorporated by reference in its entirety.

### BACKGROUND

### 1. Technical Field

The present teaching generally relates to computers. More specifically, the present teaching relates to signal processing.

### 2. Technical Background

With the advancement of technologies, more and more tasks are now performed with the assistance of computers. Different industries have benefited from such technological advancement, including the medical industry, where large volume of image data, capturing anatomical information of a patient, may be processed by computers to identify anatomical structures of interest (e.g., organs, bones, blood vessels, or abnormal nodule), obtain measurements for each object of interest (e.g., dimension of a nodule growing in an organ), and quantification of different anatomical structures (e.g., dimension and shape of abnormal nodules). Such information may be used for a variety of purposes, including enabling presurgical planning and providing guidance during a surgery. Modern laparoscopic procedures may utilize the technological advancement in the field to devise information that can facilitate navigational guide to a surgeon when performing an operation without having to cut open the body of a patient, as what traditional surgeries do.

This is illustrated in FIG. 1A, where a setting for laparoscopic procedure is shown with a patient 120 on a surgical bed 110, a laparoscopic camera 130 inserted into a patient's body. The inserted camera 130 is to observe a site of interest to capture, e.g., a surgical instrument 140 (also inserted into the patient's body) appearing at the site and the nearby an organ and possibly other anatomical structures close to the surgical instrument 140. Two dimensional (2D) images are captured by the laparoscopic camera and may be displayed (150) so that it may be viewed by a surgeon as a visual guide by mentally map what is seen in 2D images (e.g., a surgical instrument near the surface of an organ) to the actual three-dimensional (3D) object of interest (e.g., the liver to be resected in the operation) to determine which part of the liver the surgical instrument is close to in order to figure out how to manipulate the surgical instrument.

In a laparoscopic procedure, a 3D model characterizing an organ of interest may be utilized to provide 3D information corresponding to what is seen in 2D images to enhance the effectiveness of visual guide. Such a 3D model may represent both the 3D construct of the organ (e.g., a liver) but also the anatomical structures inside the organ (e.g., blood vessels, nodule(s) inside the liver). If such a 3D model can be registered with what is seen in 2D images, a projection of such a 3D model at the registered location allows the surgeon to see not only surroundings but also beneath the surface of the organ. This provides valuable navigational information to guide the surgeon to determine, e.g., how to move a cutter towards a nodule in a manner to avoid cutting blood vessels.

To utilize a 3D model to enhance a laparoscopic procedure, the pose of the laparoscopic camera may need to be estimated by registering 2D laparoscopic images captured during a surgery with the 3D model for the targeted organ is needed. To do so, in some situations, a surgeon or an assistant may manually select 2D feature points from 2D images and the corresponding 3D points on the 3D model to facilitate registration. However, such a manual approach may be impractical in actual surgeries because it is slow, cumbersome, and impossible to do it continuously with changing 2D images while the surgical instrument is moving. Thus, there is a need for a solution that addresses the challenges discussed above.

### SUMMARY

The teachings disclosed herein relate to methods, systems, and programming for information management. More particularly, the present teaching relates to methods, systems, and programming related to hash table and storage management using the same.

In one example, a method, implemented on a machine having at least one processor, storage, and a communication platform capable of connecting to a network for estimating 3D camera pose based on 2D features. 3D virtual camera poses are generated, each of which is used to determine a perspective to project a 3D model of a target organ to create a 2D image of the target organ. 2D features are extracted from each 2D image and paired with the corresponding 3D virtual camera pose to represent a mapping. A 2D feature-camera pose mapping model is obtained based on the pairs. Input 2D features extracted from a real-time 2D image of the target organ are used to map, via the 2D feature-camera pose mapping model, to a 3D pose estimate of a laparoscopic camera, which is then refined to derive an estimated 3D camera pose of the laparoscopic camera via differential rendering of the 3D model with respect to the 3D pose estimate.

In a different example, a system is disclosed for estimating 3D camera pose based on 2D features extracted from a 2D image. The system includes a 3D camera pose generator, a 2D feature-camera pose mapping model generator, and a camera pose estimator. The 3D camera pose generator is provided for generating 3D virtual camera poses are generated, each of which is used to determine a perspective to project a 3D model of a target organ. The 2D feature-camera pose mapping model generator is provided for creating a 2D image of the modeled target organ by projecting the 3D model in a perspective corresponding to each 3D virtual camera pose, extracting 2D features therefrom, pairing 2D features from each 2D image with the corresponding 3D virtual camera pose to represent a mapping, and obtain a 2D feature-camera pose mapping model based on the pairs. When input 2D features extracted from a real-time 2D image of the target organ are received, the camera pose estimator is used to map the input 2D features, via the 2D feature-camera pose mapping model, to a 3D pose estimate of a laparoscopic camera, which is then refined to derive an estimated 3D camera pose of the laparoscopic camera via differential rendering of the 3D model with respect to the 3D pose estimate.

Other concepts relate to software for implementing the present teaching. A software product, in accordance with this concept, includes at least one machine-readable non-transitory medium and information carried by the medium. The information carried by the medium may be executable program code data, parameters in association with the executable program code, and/or information related to a user, a request, content, or other additional information.

Another example is a machine-readable, non-transitory and tangible medium having information recorded thereon for estimating 3D camera pose based on 2D features. The information, when read by the machine, causes the machine to perform various steps. 3D virtual camera poses are generated, each of which is used to determine a perspective to project a 3D model of a target organ to create a 2D image of the target organ. 2D features are extracted from each 2D image and paired with the corresponding 3D virtual camera pose to represent a mapping. A 2D feature-camera pose mapping model is obtained based on the pairs. Input 2D features extracted from a real-time 2D image of the target organ are used to map, via the 2D feature-camera pose mapping model, to a 3D pose estimate of a laparoscopic camera, which is then refined to derive an estimated 3D camera pose of the laparoscopic camera via differential rendering of the 3D model with respect to the 3D pose estimate.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1A illustrates an exemplary setting for a laparoscopic procedure;

FIG. 1B shows an exemplary 3D model of an organ and a perspective to look into the 3D model from a 3D camera pose;

FIG. 1C shows a 2D image as a 2D image of a 3D model projected according to a perspective determined by a 3D camera pose;

FIG. 1D illustrates exemplary types of 2D features extracted from 2D images for estimating a 3D camera pose, in accordance with an embodiment of the present teaching;

FIG. 1E illustrates different types of 2D feature/camera pose mapping models, in accordance with an embodiment of the present teaching;

FIG. 2 depicts an exemplary high level system diagram of a 3D camera pose estimation framework, in accordance with an embodiment of the present teaching;

FIG. 3A is a flowchart of an exemplary process to learn models for mapping 2D features to a 3D camera pose in a 3D camera pose estimation framework, in accordance with an embodiment of the present teaching;

FIG. 3B is a flowchart of an exemplary process to utilize 2D feature/camera pose mapping models to estimate a 3D laparoscopic camera pose based on 2D laparoscopic images in a 3D camera pose estimation framework, in accordance with an embodiment of the present teaching;

FIG. 4A shows parameters associated with a 3D camera pose;

FIG. 4B illustrates exemplary training data generated for training 2D feature/camera pose mapping models, in accordance with an embodiment of the present teaching;

FIG. 5A depicts an exemplary high level system diagram of a camera pose estimator, in accordance with an embodiment of the present teaching;

FIG. 5B is a flowchart of an exemplary process of a camera pose estimator, in accordance with an embodiment of the present teaching;

FIG. 6A depicts an exemplary high level system diagram of an initial camera pose candidate determiner, in accordance with an embodiment of the present teaching;

FIG. 6B is a flowchart of an exemplary process of an initial camera pose candidate determiner, in accordance with an embodiment of the present teaching;

FIG. 7 is an illustrative diagram of an exemplary mobile device architecture that may be used to realize a specialized system implementing the present teaching in accordance with various embodiments; and

FIG. 8 is an illustrative diagram of an exemplary computing device architecture that may be used to realize a specialized system implementing the present teaching in accordance with various embodiments.

### DETAILED DESCRIPTION

In the following detailed description, numerous specific details are set forth by way of examples in order to facilitate a thorough understanding of the relevant teachings. However, it should be apparent to those skilled in the art that the present teachings may be practiced without such details. In other instances, well known methods, procedures, components, and/or system have been described at a relatively high-level, without detail, in order to avoid unnecessarily obscuring aspects of the present teachings.

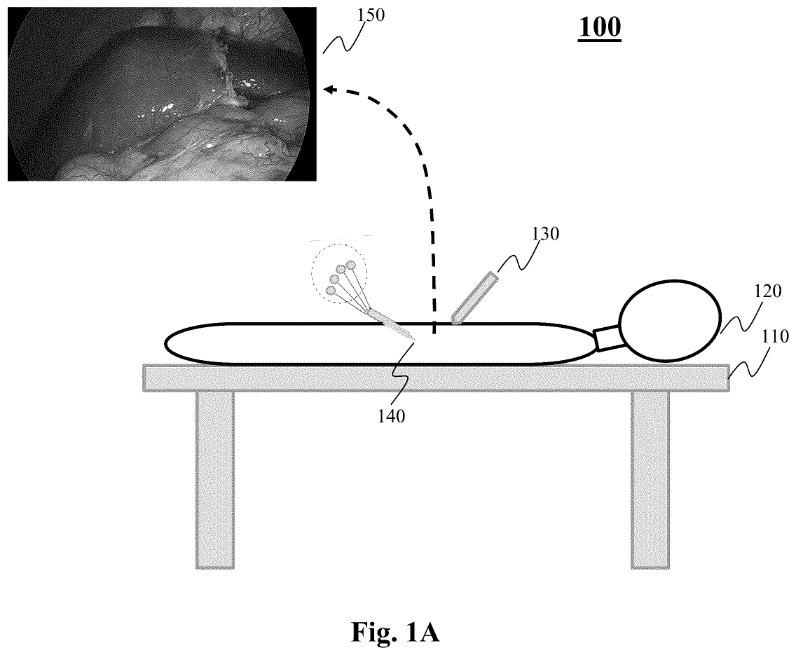

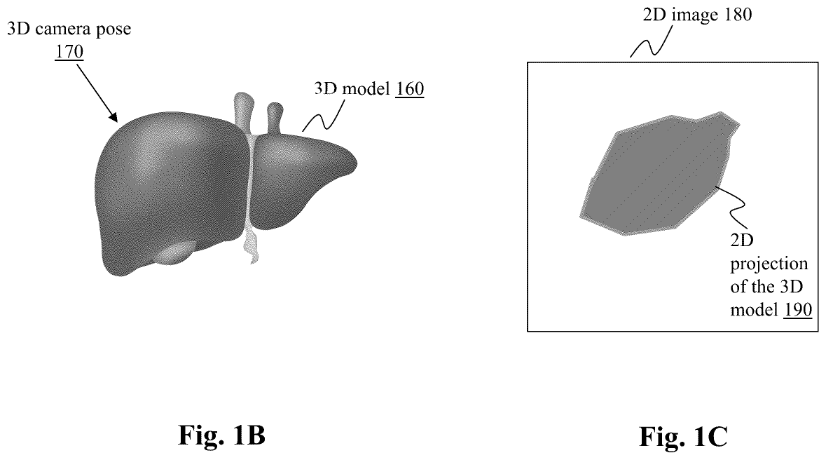

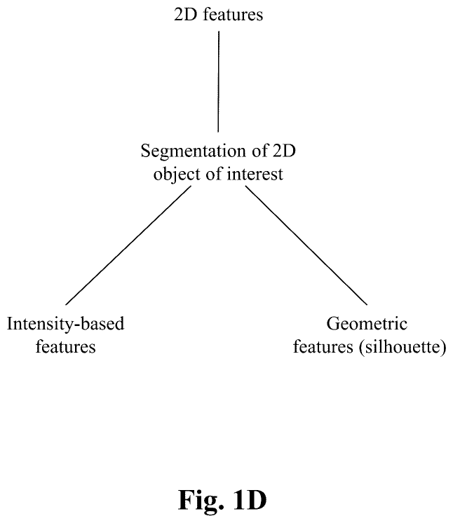

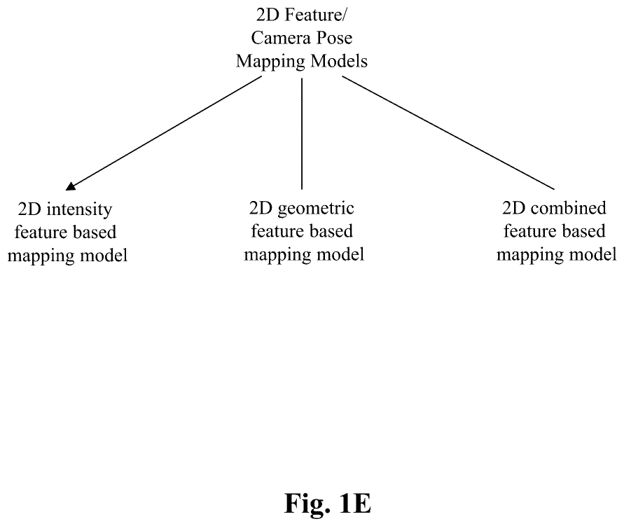

The present teaching discloses exemplary methods, systems, and implementations of a framework to estimate a 3D camera pose based on features detected from 2D images captured by the camera. The present teaching is disclosed via as an exemplary application in a laparoscopic procedure. A 3D model for an organ may be constructed to represent a target organ in terms of its physical appearance such as dimension, volume, shape, as well as various anatomical structures resided therein. Such a 3D model may be utilized to generate a model for mappings 2D features detected from 2D images captured by a camera to 3D poses of the camera. In some embodiments, different 3D camera poses may be assumed, each of which may be used to determine a corresponding perspective to render the 3D model on a 2D image plane to create a projection. Each 2D projection of the 3D model creates a 2D image. FIG. 1B shows an exemplary 3D model 160 of a target organ and a 3D camera pose 170, from where a camera may look into the 3D model 160 in a corresponding perspective to yield a 2D image 180 as shown in FIG. 1C, with a projection 190 of the 3D model 160.

Whenever the camera pose 170 changes, the projection 190 of the 3D model 160 in a 2D image acquired according to the camera pose changes accordingly. Such correspondences may be utilized to determine the relationships between 3D camera poses and 2D appearances of the projections of the 3D model 160. In some embodiments, for each projected 2D image, a segmentation may be first obtained with respect to an object of interest (target organ such as a liver), from which different 2D image features may be extracted such as intensity-related features (e.g., texture or color) and geometric features such as silhouettes or shapes of the projected organ. This is illustrated in FIG. 1D, where 2D features extracted from a segmentation may include intensity and/or geometric features of the object of interest. Such 2D features may be paired with the underlying 3D camera poses (that yield the 2D images) and such paired information may be used to establish models that can be used to map 2D features to 3D camera poses.

According to the present teaching, such mapping models may be discrete or continuous. Discrete mapping models may be constructed as lookup tables (LUTs) providing correspondences between 2D features and 3D camera poses based on the paired information. Multiple LUTs may be constructed, each of which may be based on different 2D features. For instance, a LUT may be for mapping 2D intensity features to 3D camera poses. Another LUT may be for mapping 2D geometric features such as shapes to 3D camera poses. Yet another LUT may map a combination of 2D intensity and geometric features to 3D camera poses. Although such discrete mappings are not continuous, they may, in each case, identify the closest mapping through approximation. The estimated 3D camera poses obtained via such discrete approximation may optionally be refined or optimized to improve the precision of the 3D camera poses.

In a different embodiment, continuous mapping models may be obtained, via machine learning, by using 2D features/3D camera poses pairings as training data to learn, e.g., complex relationships between 2D features and 3D camera poses so that the learned models may be used for mapping any given set of 2D features to candidate 3D camera poses. Such continuous mapping models may output multiple discrete outputs each of which corresponds to a 3D camera pose with a score, e.g., a probability, indicative of the confidence in the estimated 3D camera pose. In different embodiments, the multiple outputs from a trained mapping model may correspond to different degrees of freedom associated with 3D poses. Such a continuous mapping model may also have multiple outputs, each may relate to an estimated pose or a dimension parameter, with a corresponding confidence score associated therewith.

As discussed herein, different mapping models (either discrete or continuous) may be obtained, each of which may operate based on some set of 2D features. This is illustrated in FIG. 1E, in accordance with some embodiments of the present teaching. As illustrated, a mapping model may be obtained to map intensity-based 2D features (e.g., color or texture) to 3D camera poses. Another mapping model may be obtained to map 2D geometric features of an object to 3D camera poses. Yet another mapping model may be obtained to map a combination of features (e.g., intensity plus geometric features) to 3D camera poses. In some applications, one type of model (e.g., 2D intensity feature based mapping) may be invoked to estimate a 3D camera pose. In some applications, more than one type of models (e.g., both intensity and geometric feature-based models) may be invoked to estimate the 3D pose and then combine the estimates from different models.

As discussed herein, the output from a continuous mapping model may be a plurality of 3D camera poses each of which is associated with a score such as a probability indicating a confidence and, in some embodiments, the one with a top confidence score may be selected as the estimated 3D camera pose. Other embodiments are also possible to derive a final 3D camera pose estimate. For example, multiple (say, K) 3D camera pose estimates may be combined to generate an aggregated 3D pose estimate. For instance, top K estimates with, e.g., sufficient top confidence scores, may be aggregated in a weighted sum fashion to generate a final 3D camera pose estimate. In some situations, the weights applied to the individual estimates may be determined according to, e.g., the confidence scores associated therewith. The aggregation may be performed by computing a centroid pose in the parametric space in 6-dimensional space corresponding to the estimated 3D poses. The aggregation may also be performed by taking weighted sum of the parameter in each dimension.

In some implementations, the estimated 3D camera pose may be used as an initial estimate which may optionally be further optimized based on other means. According to the present teaching, the optimization may be via differential renderings. Based on an initial estimated 3D camera pose, the 3D model 160 may be rendered using varying rendering parameters with, e.g., perturbed intensity, to create differential projection results. In an iterative optimization process, each of the differential rendering result may be assessed against a loss function defined with respect to the pose parameters (e.g., 6-degrees of freedom) so that the 3D pose parameters may be iteratively adjusted until convergence. The refined or optimized 3D camera pose estimate may then be used as the refined 3D camera pose estimate.

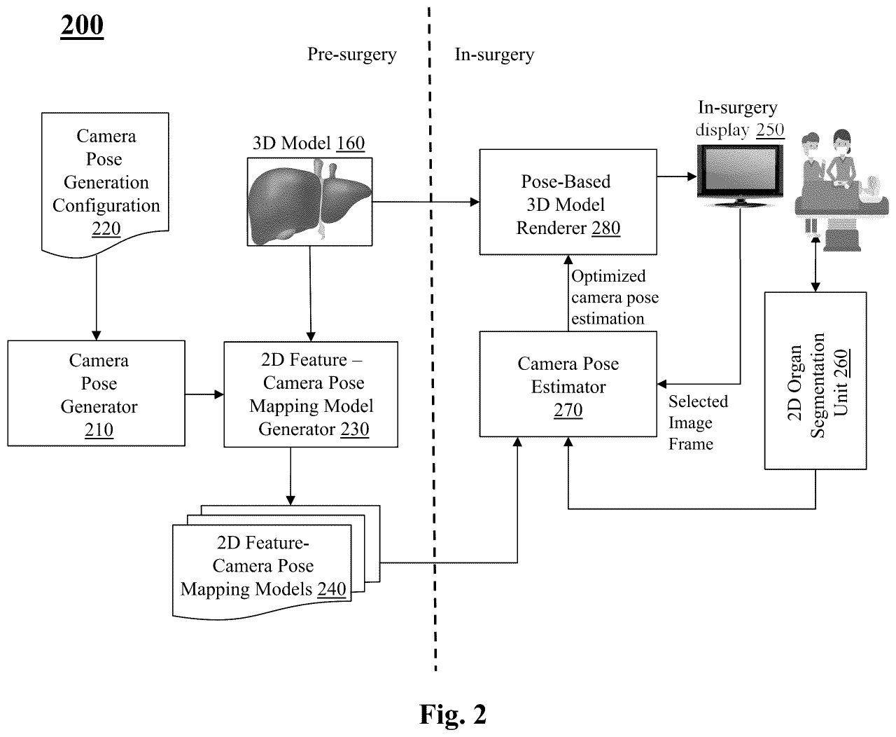

The 2D feature/3D camera pose mapping models (either discrete or continuous) may be deployed in different applications. In one example, such models may be used in a laparoscopic procedure on an organ to estimate the 3D pose of the laparoscopic camera based on 2D features extracted from real-time laparoscopic images. The estimated 3D camera pose may then be used, in conjunction with a 3D model for the organ, to determine a perspective to project the 3D model onto a display to provide a 3D visual guide that is aligned with what is seen in the 2D laparoscopic images. As a 3D model also models the anatomical structures beneath the surface of the organ (e.g., tumors or blood vessels), the aligned projection of the 3D organ model also reveals these anatomical structures to provide effective visual assistance to a surgeon in a laparoscopic procedure. Details related to the present teaching on estimating a 3D camera pose based on 2D image features are provided below with reference to FIGS. 2-FIG. 6B.

FIG. 2A depicts an exemplary high level system diagram of a 3D camera pose estimation framework 200, in accordance with an embodiment of the present teaching. Framework 200 includes two portions, one being a pre-surgery portion and the other being an in-surgery portion. The pre-surgery portion is provided for establishing 2D feature/camera pose mapping models 240 and includes a camera pose generator 210 and a 2D feature-camera pose mapping model generator 230. In this illustrated embodiment, the camera pose generator 210 is provided for generating a series of 3D camera poses in accordance with parameters specified in camera pose generation configuration 220 (specifying, e.g., the resolution of the 3D camera poses generated). Such generated 3D camera poses may then be provided to the 2D feature-camera pose mapping model generator 230, where the series of 3D camera poses are used to create the 2D feature-camera pose mapping models based on a 3D model 160.

As discussed herein, to create the mapping models, for each of the 3D camera poses from the camera pose generator 210, a perspective is determined for projecting the 3D model 160 onto a 2D image plane (determined based on the 3D camera pose). One example is shown in FIG. 1C. Based on the projection, 2D features are extracted (e.g., the region occupied by the projected organ is segmented, intensity features and/or geometric features for the segment may be computed) and paired with the 3D camera pose used to determine the projection. In this manner, pairs of 2D features and 3D camera poses are created and are used to build the 2D feature-camera pose mapping models 240. As discussed herein, in some embodiments, the pairs may be used to build discrete models as lookup tables (LUTs). This may work well when the resolution used to generate the 3D camera poses is adequately high so that the approximation in estimating 3D camera poses is relatively accurate. In other embodiments, the created pairs of 2D features and 3D camera poses may be used as training data in a machine learning process to learn continuous mapping models as discussed herein. Such obtained mapping models 240 may then be used during a surgery to estimate 3D camera poses based on 2D features extracted from 2D images acquired during the surgery.

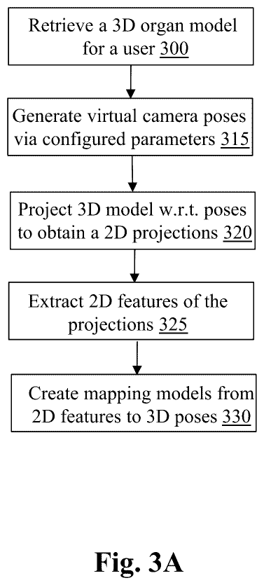

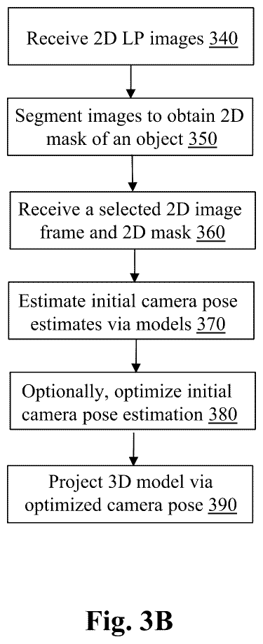

FIG. 3A is a flowchart of an exemplary process of the first portion of the framework 200 for establishing models for mapping 2D features to a 3D camera pose, in accordance with an embodiment of the present teaching. A 3D model 160 for a target object (e.g., an organ) is first retrieved at 300. To generate mapping models, the camera pose generator 210 generates, at 315, various virtual 3D camera poses according to generation parameters (e.g., resolution, etc.) specified in configuration 220. Such generated virtual 3D camera poses are sent to the 2D feature-camera pose mapping model generator 230, which projects, at 320, the 3D model 160 in different perspectives determined according to the virtual 3D camera poses to obtain corresponding 2D projected images. 2D features may then be extracted, at 325, from the 2D projected images and used to create pairs of 2D features and virtual 3D camera poses. As discussed herein, such pairs may be used to create, at 330, 2D feature-camera pose mapping models 240, which may either be discrete or continuous. In operation, depending on the types of models to be created (e.g., whether discrete or continuous, based on specific types of 2D features, etc.), the operation of the 2D feature-camera pose mapping model generator 230 may differ. For instance, the pairs of 2D features and virtual 3D camera poses may be used to directly create discrete mapping models. On the other hand, if continuous mapping models are needed, such pairs may be used as training data for machine learning to derive respective continuous mapping models.

As discussed herein, the present teaching of estimating 3D camera poses based on 2D features may be applied to different applications, including in medical procedures such as a laparoscopic procedure. The second portion of the framework 200, as shown in FIG. 2A using a laparoscopic procedure as an example, includes an in-surgery display 250, a 2D organ segmentation unit 260, a camera pose estimator 270, and a pose-based 3D model renderer 280. The in-surgery display 250 is provided in a surgery room for displaying 2D images acquired by a camera inserted into a patient's body, such as a laparoscopic camera 130 as illustrated in FIG. 1A. Such acquired 2D images are processed by the 2D organ segmentation unit 260 to segment an object of interest, e.g., a target organ such as a liver. Such 2D image processing may be performed on different 2D images. In some embodiments, via interaction with a user (e.g., a surgeon) in the surgery room, a particular 2D image may be selected and used to estimate a corresponding 3D camera pose.

The camera pose estimator 270 is provided for estimating a 3D camera pose corresponding to a selected 2D image (via interaction on a display) with an object of interest segmented therein and features thereof by relying on the 2D feature-camera pose mapping models 240, according to the present teaching. With the estimated 3D camera pose from the camera pose estimator 270, the pose-based 3D model renderer 280 is provided to use the estimated 3D camera pose to determine a perspective of projecting the 3D model 160 of the object of interest. This creates a projection of the 3D model 160 in the perspective in alignment with what is visible in the selected 2D image frame. The rendered 3D organ model provides a more effective visual guidance to a surgeon because it reveals the anatomical structures inside of the organ which is not otherwise visible in the selected 2D image. In some embodiments, the 3D model 160 may be rendered by superimposing the projection on the 2D images. In other embodiments, the 3D model 160 may be rendered separately, e.g., in either a different display window of the same display screen (on which the 2D images are shown) or on a different display device. The projected 3D model 160 may be shown side-by-side with the 2D images to provide effective visual guide to the surgeon.

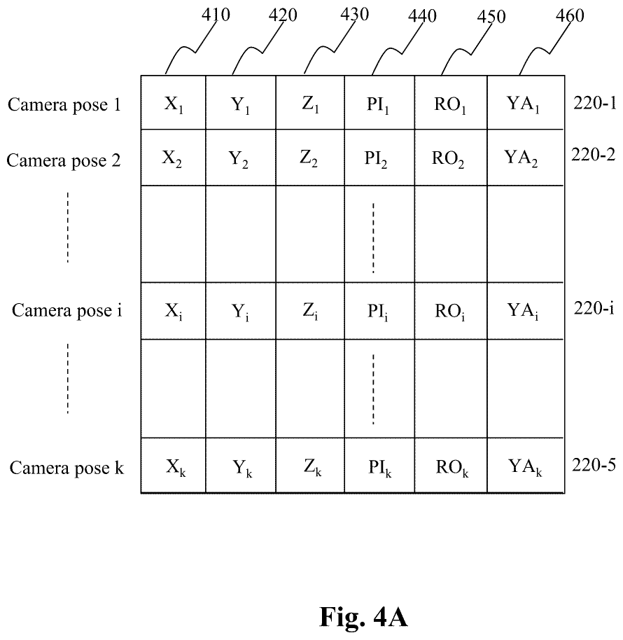

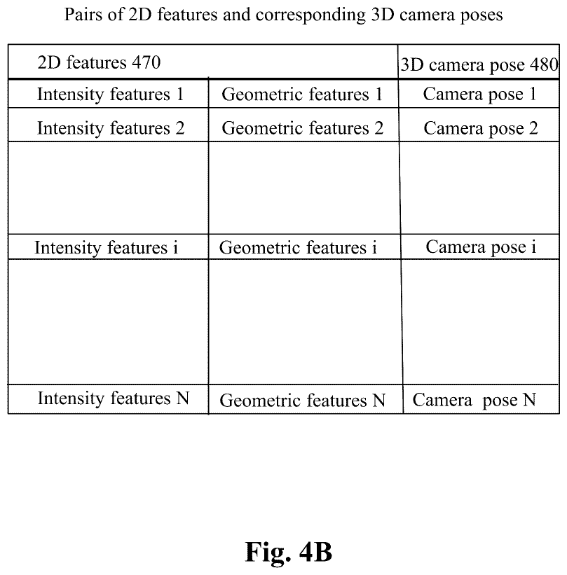

FIG. 3B is a flowchart of an exemplary process of the second portion of framework 200 for using the 2D feature-camera pose mapping models 240 to estimate a 3D laparoscopic camera pose based on 2D images, in accordance with an embodiment of the present teaching using a laparoscopic procedure as an example. In a laparoscopic procedure, 2D laparoscopic images are first received at 340 and the 2D organ segmentation unit 260 segments, at 350, one or more of the received 2D images to obtain a segmentation result. In some embodiment, segmentation result for a 2D image may include a mask representing the segmented target object (organ). In some embodiments, via interaction with a surgeon in the operation room, one of the 2D images may be selected and the segmentation result thereof may be sent to the camera pose estimator 270, which then estimates, at 370, a 3D pose of the laparoscopic camera using the 2D feature-camera pose mapping models 240. As discussed herein, the initial 3D camera pose estimate output from the camera pose estimator 270 may be optionally optimize, further at 380. The estimated 3D camera pose from the camera pose estimator 270 (either initial or optimized) may then be used by the pose-based 3D model renderer 280 to project, at 390, the 3D model 160 for the organ on a display according to a perspective determined by the 3D camera pose estimate to generate a 3D visual guide to the surgeon. Details related to the camera pose estimator 270 are provided below with reference to FIGS. 4A-6B.

FIG. 4A shows various 3D camera poses and parameters thereof used to represent them. As commonly known and shown in FIG. 4A, a camera located in a 3D space has six degrees of freedom and each camera pose may have its 3D coordinate in the 3D space, represented by (X, Y, Z) (410, 420, 430), and orientation, represented by pitch (440), roll (450), and yaw (460). As discussed herein, to create 2D feature-camera pose mapping models 240, pairs of 3D camera poses and corresponding 2D features extracted from 2D projections of the 3D model 160 based on such 3D camera poses are generated. FIG. 4B illustrates exemplary information pairs used for generating 2D feature-camera pose mapping models 240, in accordance with an embodiment of the present teaching. As shown in FIG. 4B, each pair corresponds to one row with 2D features 470 and a 3D camera pose 480. In some embodiments, these pairs may be used directly as a LUT as discrete mapping models. When continuous mapping models are to be generated, these pairs are used as training data for machine learning the mapping models.

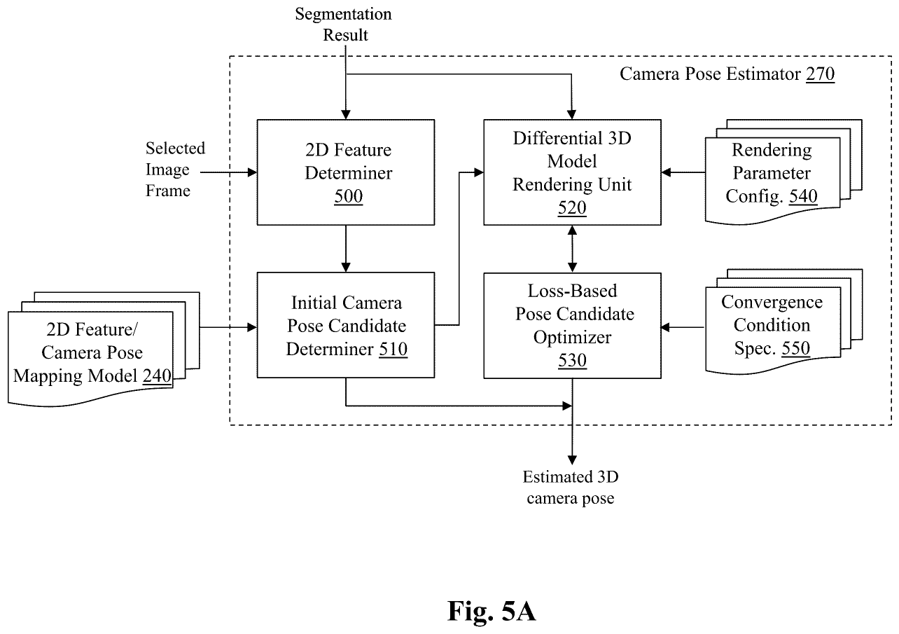

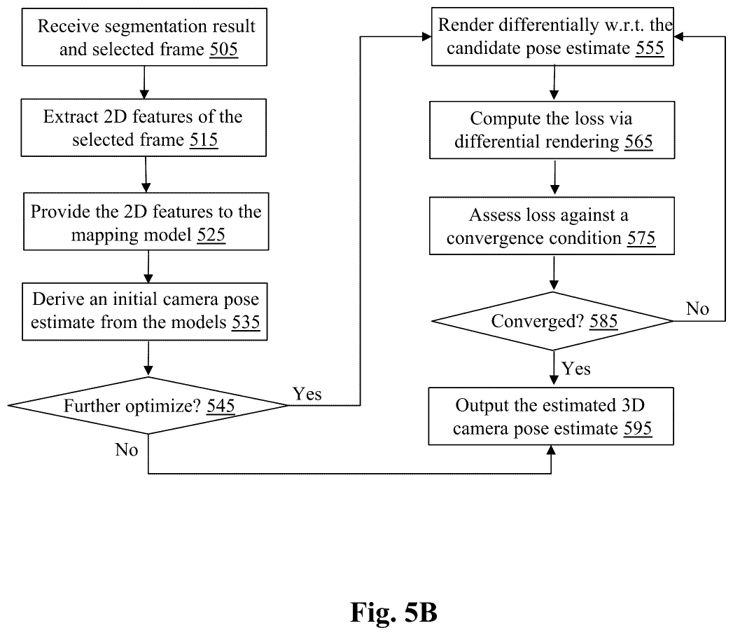

FIG. 5A depicts an exemplary high level system diagram of the camera pose estimator 270, in accordance with an embodiment of the present teaching. In this illustrated embodiment, there are two parts. The first part includes a 2D feature determiner 500 and an initial camera pose candidate determiner 510 for generating an initial camera pose estimate. The 2D feature determiner 500 is provided for extracting 2D features by segmenting an object of interest (e.g., a targeted organ) from a 2D image and provide the 2D features to the initial camera pose candidate determiner 510, which is to obtain an initial 3D camera pose estimate based on the 2D features in accordance with the mapping models 240 established prior to the surgery. As discussed herein, in some embodiments, the initial 3D camera pose candidate may be output as the estimated 3D camera pose. In some embodiments, the initial 3D camera pose may be further optimized. This may be done by the second part of the camera pose estimator 270.

The second part includes a differential 3D model rendering unit 520 and a loss-based pose candidate optimizer 530. As discussed herein, the initial estimate for a 3D camera pose may be further optimized to refine the pose parameters in different degrees of freedom, including its coordinate, its pitch, roll, and yaw. In some embodiments, this may be achieved by generating differential renderings of the 3D model 160 via the differential 3D model rendering unit 520 using perturbed pose parameters specified, e.g., in rendering parameter configuration 540. Based on each differential rendering result, the loss-based pose candidate optimizer 530 may evaluate the loss associated with the differential rendering result. If the loss does not satisfy a convergence condition specified in 550, the loss-based pose candidate optimizer 530 may adjust the pose parameters of the estimated 3D pose by minimizing the loss. Then the adjusted pose parameters are used to render, in the next iteration, the 3D model 160. The optimization process may be carried out iteratively until the convergence condition 550 is met.

In some embodiments, the loss function may be defined as follows:

$$L = {L}_{1} ( {I}_{s e g} - {I}_{s i l} ) + w \cdot {L}_{2} ( {I}_{input} - {I}_{r g b} )$$

where L₁ corresponds to a loss computed based on geometric feature (e.g., shape or silhouette of a segmented organ), L₂ corresponds to a loss computed based on intensity-based 2D features, I_{seg} is the segmented mask from the selected 2D image Iᵢₙₚᵤₜ, Iₛᵢₗ is a geometric feature image with a silhouette of the mask, I_{rgb} is the rendered RGB color image, and w is a weight for the color image loss. The overall loss L is a summation of the geometric feature-based loss L₁ and the intensity-based loss L₂. To compute the adjustment to the pose parameters, in an illustrative embodiment, a derivative function of loss with respect to camera pose parameters (e.g., θ), or cu, may be computed. A stochastic gradient descent (SGD) algorithm may then be used to update the camera pose parameters in the following exemplary process:
θ₀: Initial camera pose parameters
   while θₜ not converge do

$$t ← t + 1 {θ}_{t} ← {θ}_{t - 1} - α \frac{\partial L}{\partial θ}$$

where a is a learning parameter or learning rate. It is understood that the disclosed formulation of the optimizing the parameters of the estimated camera pose is merely for illustration and is not intended herein as a limitation. Other iterative loss-based parameter optimization scheme or formulation of the loss function used may be used to optimize the estimated pose parameters against appropriate convergence conditions. Upon convergence, the optimized 3D camera pose may then be output as the estimated 3D camera pose.

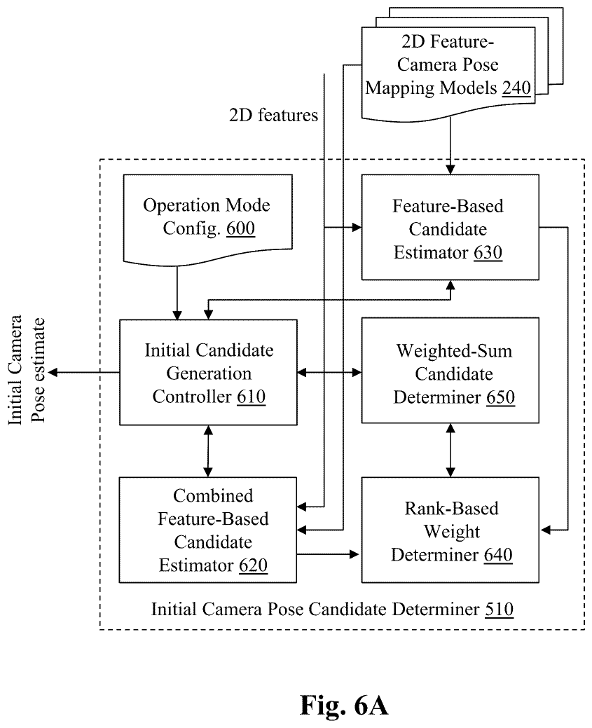

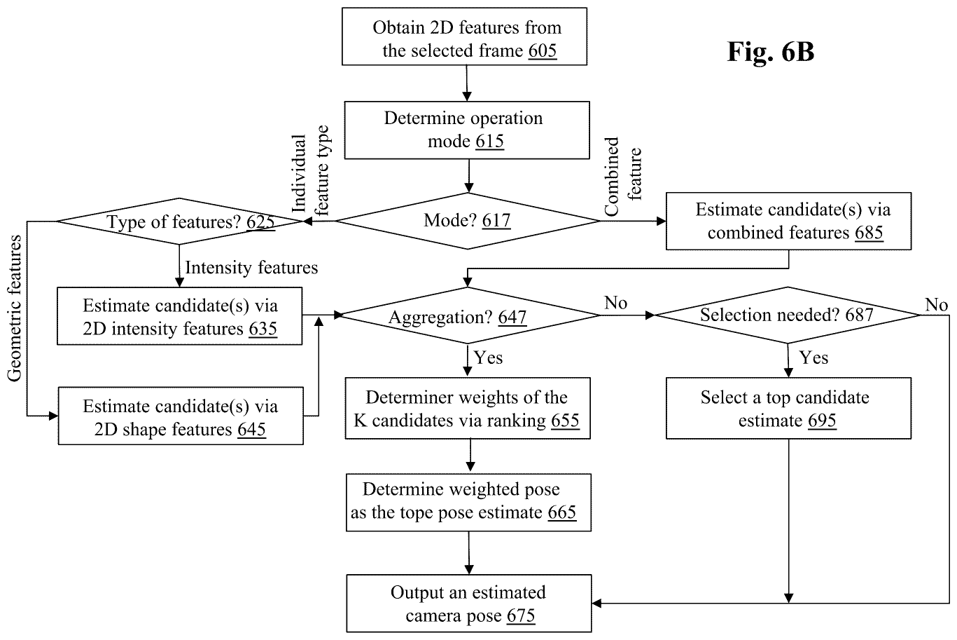

FIG. 5B is a flowchart of an exemplary process of the camera pose estimator 270, in accordance with an embodiment of the present teaching. In operation, when the 2D feature determiner 500 receives, at 505, an input 2D image and a segmentation result thereof, it processes the selected 2D image to extract, at 515, 2D features from the 2D image based on the segmentation result. The extracted 2D features are then provided, at 525, to the initial camera pose candidate determiner 510, which then derives, at 535, an initial camera pose estimate based on the 2D feature-camera pose mapping models 240. Details regarding the initial camera pose candidate determiner 510 are disclosed with reference to FIGS. 6A-6B.

With the initial 3D camera pose estimated, if it is configured not to be further optimized, determined at 545, the initial 3D camera pose estimate is output at 595. If it is configured to further refine the initial camera pose estimate, the differential 3D model rendering unit 520 and the loss-based pose candidate optimizer 530 may be invoked to conduct an iterative optimization process to produce optimized 3D camera pose estimate. In each iteration, the differential 3D model rendering unit 520 first renders, at 555, differentially the 3D model 160 with respect to the current candidate pose parameters. The differentially rendered 3D model may then be evaluated by the loss-based pose candidate optimizer 530 to compute, at 565, a loss L and assesses, at 575, the loss L against a pre-determined convergence condition. If the loss L satisfies the convergence condition, determined at 585, the refined 3D camera pose is output, at 595, as the optimized 3D camera pose estimate. If the convergence condition is not met, the process proceeds to step 555 to start the next iteration by generating another differential rendering of the 3D model 160 based on perturbed pose parameters determined by minimizing the loss function.

FIG. 6A depicts an exemplary high level system diagram of the initial camera pose candidate determiner 510, in accordance with an embodiment of the present teaching. In this illustrated embodiment, an initial camera pose may be estimated in different operation modes, depending on the configuration specified in an operation mode configuration 600. The initial camera pose estimator 510 takes 2D features as input and outputs an initial camera pose estimate using the 2D feature-camera pose mapping models 240. In this illustrated embodiment, the initial camera pose estimator 510 comprises an initial candidate generation controller 610, a feature-based candidate estimator 630, a combined feature-based candidate estimator 620, a rank-based weight determiner 640, and a weight-sum candidate determiner 650. The initial candidate generation controller 610 is provided for controlling the estimation process based on a configured operation mode retrieved from storage 600 and then carrying out the estimation according to the configured operation mode by invoking appropriate components to determine an initial 3D camera pose based on input 2D features.

As discussed herein, the 2D feature-camera pose mapping models 240 may include multiple models developed to map from input 2D features to 3D camera poses. As discussed herein, some models may be directed to map intensity-based 2D features to 3D camera poses, some may be directed to map 2D geometric features to 3D camera poses, and some may be directed to map a combined set of intensity and geometric features from a 2D image to a corresponding 3D camera pose. The operation mode adopted in an application may be configured according to the needs of the application and each operation mode may invoke a certain mapping model. For example, if the operation mode is to use 2D geometric features extracted from 2D images to estimate 3D camera poses, the mapping model constructed for mapping 2D geometric features to 3D poses may be invoked to perform the estimation. Under this mode, the feature-based candidate estimator 630 may be invoked with an input indicative of the type of 2D features to be used for the mapping. Based on the input, the feature-based candidate estimator 630 may accordingly operate by retrieving the mapping model that operates based on 2D geometric features to obtain estimated 3D pose(s).

In the case that the mapping models are discrete models, a 3D camera pose may be selected from an appropriately invoked LUT mapping model. Based on an LUT based mapping model, the initial camera pose estimate may be determined in different ways. For instance, input 2D features (extracted from a 2D image during a surgery) may be used to compare with the 2D features stored in each row of the LUT mapping models (an example is shown in FIG. 4B) to identify a matching row, which may be determined based on, e.g., a similarity between the two sets of 2D features. In some embodiments, the similarity measure between two sets of 2D features may be measured via a Euclidean distance L₂ between the two sets of features. In some embodiments, a geometric based metric (L₁) representing the similarity between two 2D geometric regions A and B (geometric features representing a segmented region stored in the LUT before the surgery and that representing a segmented region from a real time 2D image acquired during the surgery) may be used. An exemplary metric may be a Dice metric, which may be computed as Dice (A, B)=2 (A∩B)/(A+B)=L₁, wherein n is an intersection of two regions A and B. Another exemplary metric for measuring the similarity between two 2D regions may be intersection over union (IoU), which may be defined as IoU=(A∩B)/(A∪B)=L₁, where U is a union of two regions A and B.

In some embodiments, different types of 2D features may be used in a sequence when selecting a camera pose candidate using mapping models. For instance, L₂ may first be used to select K candidates based on a mapping model directed to intensity feature based mappings. Then L₁ may be further computed (either Dice or IoU) for such K candidates, some of which may further be identified as candidates based on a different mapping model directed to, e.g., geometric features. In some embodiments, L₁ and L₂ may be combined in some fashion to select candidate camera pose estimates based on yet another mapping model directed to combined 2D features. In some embodiments, the operation mode may be specified to select one top camera pose candidate, which may or may not be further optimized. In some embodiments, the operation mode may specify to select multiple camera pose candidates using appropriate mapping models that have the highest similarities with stored 2D features in the mapping models.

When continuous mapping models are used to determine an initial camera pose estimate, a mapping model learned via, e.g., machine learning, may simultaneously produce multiple 3D pose estimates with, e.g., a confidence score associated with each estimate. In some operation mode, a top candidate may be selected from these multiple candidates as the initial camera pose estimate, e.g., the estimate with the highest confidence score. In some operation mode, multiple 3D camera pose estimates from a continuous mapping model may be aggregated to generate an aggregated candidate as the initial camera pose estimate.

As discussed herein, with the input indicating the type(s) of 2D features to be used for the estimation, the feature-based candidate estimator 630 may operate accordingly. If the input indicates that the 3D camera poses are to be estimated based on 2D intensity features, mapping models constructed for mapping 2D intensity features to 3D poses may be retrieved for the estimation. If the input indicates the use of 2D geometric features for estimation, mapping models constructed for mapping 2D geometric features to 3D camera poses may be applied for the estimation. If the estimation result is a single 3D camera pose estimate (selected from either discrete LUT or continuous mapping model(s)), the estimate is provided to the initial candidate generation controller 610 as the initial camera pose estimate. If the estimation result includes multiple 3D camera pose candidates (from either LUT or continuous mapping model(s)), the multiple 3D camera pose candidates may then be used (e.g., for aggregation) to generate the initial camera pose estimate.

Another mode of operation is to map combined 2D features (e.g., 2D intensity and geometric features) to 3D pose candidates. In this case, the combined feature-based candidate estimator 620 may be invoked for the estimation based on either LUT or continuous mapping models. Similarly, if a single candidate is produced, it is provided to the initial candidate generation controller 610 as the initial camera pose estimate. If multiple candidates are produced, the multiple 3D camera poses may then be used to generate (e.g., via selection or aggregation) the initial camera pose estimate.

In some embodiments, to obtain an initial camera pose estimate from multiple candidates, a top candidate may be selected based on some criterion. For example, the selection may be based on the similarity measures associated with the candidate estimates produced using, e.g., LUT mapping models. On the other hand, if the candidates are produced using continuous mapping models, the selection may be based on the confidence scores associated with the candidate estimates. A candidate with a best measure (either similarity or confidence score) may be selected. In some embodiments, instead of selecting a top candidate estimate, multiple candidate estimates may be combined to generate a single estimate, e.g., an estimate derived using a weighted sum of the multiple candidate estimates. To support that operation, the rank-based weight determiner 640 and the weighted-sum candidate determiner 650 are provided for generating an aggregated initial camera pose estimate based on multiple candidate estimates with corresponding confidence scores.

In the illustrated embodiment, the rank-based weight determiner 640 may operate to rank the multiple candidates. In some embodiments, the ranking may be based on their relevant scores. Candidates selected from LUS mapping models may be associated with similarity scores determined when matching 2D features from an in-surgery 2D image and 2D features stored in the LUT mapping models. Candidates produced by the continuous mapping models may also have associated confidence scores. The ranking may be performed based on such numerical scores in a descending order and the candidates may be determined based on their respective rankings. The scores may be used as weights for the candidates so selected. The weighted sum-based candidate determiner 650 may compute an aggregated 3D camera pose estimate by taking, e.g., a weighted sum of the candidates. Such generated aggregated camera pose estimate may then be provided as the initial camera pose estimate.

FIG. 6B is a flowchart of an exemplary process of the initial camera pose candidate determiner 510, in accordance with an embodiment of the present teaching. 2D features extracted by the 2D feature determiner 500 are first received at 605. The initial candidate generation controller 610 may determine, at 615, a specified operation mode configured in 600. If the operation mode is to estimate the 3D camera pose using individual type 2D feature, determined at 617, the feature-based candidate estimator 630 is invoked for carrying out the estimation by invoking appropriate mapping model corresponding to the type of 2D features. If 2D intensity features are to be used for estimation, determined at 625, 3D camera pose candidate(s) may be estimated, at 645, using mapping models constructed using 2D intensity features. If 2D geometric features are to be used for the estimation, 3D camera pose candidate(s) may be estimated, at 655, using mapping models constructed for 2D geometric features. If the operation mode is configured for using combined 2D features for the estimation, the combined feature-based candidate estimator 620 is invoked to estimate, at 685, 3D camera pose candidate(s) based on mapping models constructed based on combined features.

When there are multiple candidates produced using the mapping models, they may either be aggregated to produce or used to select a single individual estimate as the initial camera pose estimate. Based on the candidate estimate(s) mapped based on 2D features (either individual type or combined), it is further determined, at 647, whether the estimated candidate(s) is to be aggregated. There are several situations where aggregation is not needed. One is when the mapping models produce only one individual estimate. Another situation is when the operation is configured not to aggregate but to select a best estimate. In the former situation, the only estimate may be used directly as the initial camera pose estimate and no selection is needed. In the latter situation, the initial camera pose may be selected from the multiple 3D camera pose estimates. After it is determined that no aggregation is needed at 647, it is further determined at 687 whether a selection is to be made. In case of multiple camera pose estimates exist, if aggregation is not needed, a selected is needed (determined at 687). In this case, a top estimated candidate may be selected, at 695, from multiple candidates based on certain selection criterion, e.g., the estimate with a best score such as a highest similarity (in case LUT model is used) or a maximum confidence score (when a continuous mapping model is used). If no selection is needed, this may correspond to the situation that there is only one estimate and in this case, the estimate is output at 675 as the estimated initial 3D camera pose.

If the configuration indicates to derive the initial 3D camera pose estimate by aggregating multiple estimated camera pose candidates, determined at 647, aggregation may be performed to obtain the aggregated estimate. In some embodiments, the rank-based weight determiner 640 ranks the multiple estimated camera pose candidates according to, e.g., their confidence scores and compute the weight to each candidate, at 655, based on its corresponding ranking. Such determined weights are then provided to the weighted sum-based candidate determiner 650 so that the multiple camera pose candidates may be aggregated as a weighted sum to determine, at 665, an aggregated pose, which is then output, at 675, as the initial camera pose estimate. According to the flow of the process illustrated in FIG. 6B, an initial 3D camera pose may be estimated in different operational mode using different mapping models based on the needs of an application. As discussed herein, the output initial 3D camera pose estimate may be used directly to project the 3D model to provide a 3D visual guide or may be further optimized to generate a refined 3D camera pose before it is used for rendering.

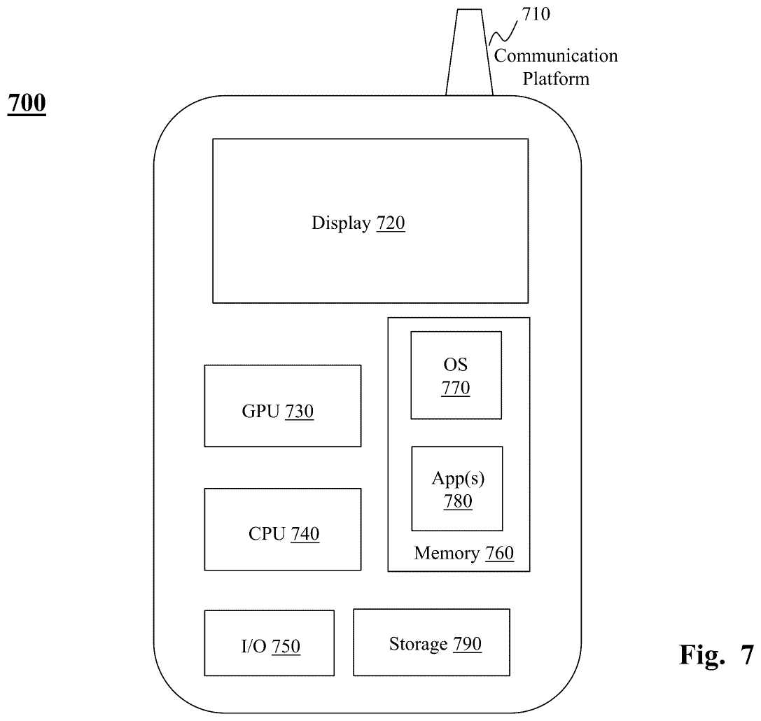

FIG. 7 is an illustrative diagram of an exemplary mobile device architecture that may be used to realize a specialized system implementing the present teaching in accordance with various embodiments. In this example, the user device on which the present teaching may be implemented corresponds to a mobile device 700, including, but not limited to, a smart phone, a tablet, a music player, a handled gaming console, a global positioning system (GPS) receiver, and a wearable computing device, or in any other form factor. Mobile device 700 may include one or more central processing units (“CPUs”) 740, one or more graphic processing units (“GPUs”) 730, a display 720, a memory 760, a communication platform 710, such as a wireless communication module, storage 790, and one or more input/output (I/O) devices 750. Any other suitable component, including but not limited to a system bus or a controller (not shown), may also be included in the mobile device 700. As shown in FIG. 7, a mobile operating system 770 (e.g., iOS, Android, Windows Phone, etc.), and one or more applications 780 may be loaded into memory 760 from storage 790 to be executed by the CPU 740. The applications 780 may include a user interface or any other suitable mobile apps for information analytics and management according to the present teaching on, at least partially, the mobile device 700. User interactions, if any, may be achieved via the I/O devices 750 and provided to the various components connected via network(s).

To implement various modules, units, and their functionalities described in the present disclosure, computer hardware platforms may be used as the hardware platform(s) for one or more of the elements described herein. The hardware elements, operating systems and programming languages of such computers are conventional in nature, and it is presumed that those skilled in the art are adequately familiar with to adapt those technologies to appropriate settings as described herein. A computer with user interface elements may be used to implement a personal computer (PC) or other type of workstation or terminal device, although a computer may also act as a server if appropriately programmed. It is believed that those skilled in the art are familiar with the structure, programming, and general operation of such computer equipment and as a result the drawings should be self-explanatory.

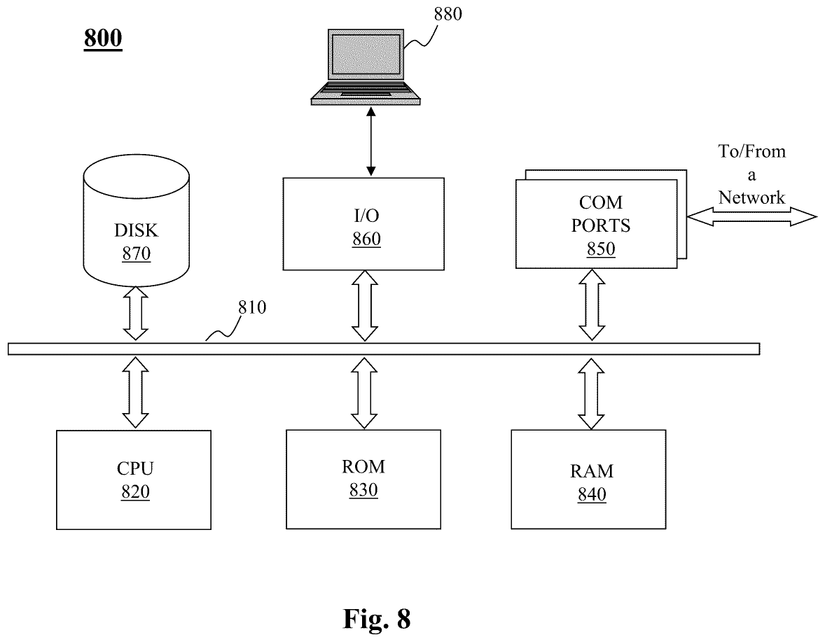

FIG. 8 is an illustrative diagram of an exemplary computing device architecture that may be used to realize a specialized system implementing the present teaching in accordance with various embodiments. Such a specialized system incorporating the present teaching has a functional block diagram illustration of a hardware platform, which includes user interface elements. The computer may be a general-purpose computer or a special purpose computer. Both can be used to implement a specialized system for the present teaching. This computer 800 may be used to implement any component or aspect of the framework as disclosed herein. For example, the information analytical and management method and system as disclosed herein may be implemented on a computer such as computer 800, via its hardware, software program, firmware, or a combination thereof. Although only one such computer is shown, for convenience, the computer functions relating to the present teaching as described herein may be implemented in a distributed fashion on a number of similar platforms, to distribute the processing load.

Computer 800, for example, includes COM ports 850 connected to and from a network connected thereto to facilitate data communications. Computer 800 also includes a central processing unit (CPU) 820, in the form of one or more processors, for executing program instructions. The exemplary computer platform includes an internal communication bus 810, program storage and data storage of different forms (e.g., disk 870, read only memory (ROM) 830, or random-access memory (RAM) 840), for various data files to be processed and/or communicated by computer 800, as well as possibly program instructions to be executed by CPU 820. Computer 800 also includes an I/O component 860, supporting input/output flows between the computer and other components therein such as user interface elements 880. Computer 800 may also receive programming and data via network communications.

Hence, aspects of the methods of information analytics and management and/or other processes, as outlined above, may be embodied in programming. Program aspects of the technology may be thought of as “products” or “articles of manufacture” typically in the form of executable code and/or associated data that is carried on or embodied in a type of machine-readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, in connection with information analytics and management. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution, e.g., an installation on an existing server. In addition, the techniques as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one processor, a memory, and a communication platform, comprising:
generating a plurality of three-dimensional (3D) virtual camera poses;
with respect to each of the plurality of 3D virtual camera poses,
projecting a 3D model for a target organ onto a (two-dimensional) 2D image plane determined based on the 3D virtual camera pose to generate a virtual 2D image of the target organ in a perspective corresponding to the 3D virtual camera pose,
obtaining 2D features of the virtual 2D image, and
creating a pair representing a mapping from the 2D features to the 3D virtual camera pose;
obtaining a 2D feature-camera pose mapping model based on the pairs of 2D features and the plurality of 3D virtual camera poses;
obtaining a 3D pose estimate of a laparoscopic camera by mapping, via the 2D feature-camera pose mapping model, input 2D features extracted from a real-time 2D image of the target organ acquired by the laparoscopic camera to the 3D camera estimate; and
refining the 3D pose estimate to derive an estimated 3D camera pose of the laparoscopic camera via differential rendering of the 3D model with respect to the 3D pose estimate.

2. The method of claim 1, wherein the 2D features include one or more of:
intensity features characterizing the appearance of the 3D model when projected to the 2D image plane; and
geometric features characterizing the shape of the projected 3D model in the 2D image plane.

3. The method of claim 2, wherein the step of obtaining 2D features comprises:
processing the 2D image to obtain a segmentation of the target organ;
computing the intensity features within the segmentation; and
determining the geometric features of the target organ based on the segmentation.

4. The method of claim 1, wherein the step of obtaining the 2D feature-camera pose mapping model comprises:
constructing a look-up table (LUT) based on the pairs, wherein the LUT represents relationships between 2D features extracted from 2D images and 3D camera poses.

5. The method of claim 1, wherein the step of obtaining the 2D feature-camera pose mapping model comprises:
generating training data based on the pairs; and
obtaining, via machine learning, the 2D feature-camera pose mapping model capable of mapping input 2D features to a 3D camera pose.

6. The method of claim 1, wherein the input 2D features are obtained by:
acquiring, during a surgery via the laparoscopic camera positioned at a 3D camera pose, the real time 2D image of the target organ;
processing the real time 2D image to generate a segmentation of the target organ;
extracting input 2D features of the target organ as it appears in the real time 2D image.

7. The method of claim 1, wherein the step of refining the 3D pose estimate by:
generating a perturbed 3D camera pose based on the 3D pose estimate;
creating a differential rendering of the 3D model based on the perturbed 3D camera pose;
computing a loss based on the discrepancy between the real time 2D image and the differential rendering;
outputting the perturbed 3D camera pose as the estimated 3D camera pose of the laparoscopic camera, if the loss satisfies a convergence condition; and
repeating the steps of generating, creating, computing, and outputting until the perturbed 3D camera pose yields a differential rendering that satisfies the convergence condition.

8. A machine-readable medium having information recorded thereon, wherein the information, when read by the machine, causes the machine to perform the following steps:
generating a plurality of three-dimensional (3D) virtual camera poses;
with respect to each of the plurality of 3D virtual camera poses,
projecting a 3D model for a target organ onto a (two-dimensional) 2D image plane determined based on the 3D virtual camera pose to generate a virtual 2D image of the target organ in a perspective corresponding to the 3D virtual camera pose,
obtaining 2D features of the virtual 2D image, and
creating a pair representing a mapping from the 2D features to the 3D virtual camera pose;
obtaining a 2D feature-camera pose mapping model based on the pairs of 2D features and the plurality of 3D virtual camera poses;
obtaining a 3D pose estimate of a laparoscopic camera by mapping, via the 2D feature-camera pose mapping model, input 2D features extracted from a real-time 2D image of the target organ acquired by the laparoscopic camera to the 3D camera estimate; and
refining the 3D pose estimate to derive an estimated 3D camera pose of the laparoscopic camera via differential rendering of the 3D model with respect to the 3D pose estimate.

9. The medium of claim 8, wherein the 2D features include one or more of:
intensity features characterizing the appearance of the 3D model when projected to the 2D image plane; and
geometric features characterizing the shape of the projected 3D model in the 2D image plane.

10. The medium of claim 9, wherein the step of obtaining 2D features comprises:
processing the 2D image to obtain a segmentation of the target organ;
computing the intensity features within the segmentation; and
determining the geometric features of the target organ based on the segmentation.

11. The medium of claim 8, wherein the step of obtaining the 2D feature-camera pose mapping model comprises:
constructing a look-up table (LUT) based on the pairs, wherein the LUT represents relationships between 2D features extracted from 2D images and 3D camera poses.

12. The medium of claim 8, wherein the step of obtaining the 2D feature-camera pose mapping model comprises:
generating training data based on the pairs; and
obtaining, via machine learning, the 2D feature-camera pose mapping model capable of mapping input 2D features to a 3D camera pose.

13. The medium of claim 8, wherein the input 2D features are obtained by:
acquiring, during a surgery via the laparoscopic camera positioned at a 3D camera pose, the real time 2D image of the target organ;
processing the real time 2D image to generate a segmentation of the target organ;
extracting input 2D features of the target organ as it appears in the real time 2D image.

14. The medium of claim 8, wherein the step of refining the 3D pose estimate by:
generating a perturbed 3D camera pose based on the 3D pose estimate;
creating a differential rendering of the 3D model based on the perturbed 3D camera pose;
computing a loss based on the discrepancy between the real time 2D image and the differential rendering;
outputting the perturbed 3D camera pose as the estimated 3D camera pose of the laparoscopic camera, if the loss satisfies a convergence condition; and
repeating the steps of generating, creating, computing, and outputting until the perturbed 3D camera pose yields a differential rendering that satisfies the convergence condition.

15. A system comprising:
a camera pose generator implemented by a processor and configured for generating a plurality of three-dimensional (3D) virtual camera poses;
a two-dimensional (2D) feature-camera pose mapping model generator implemented by a processor and configured for, with respect to each of the plurality of 3D virtual camera poses,
projecting a 3D model for a target organ onto a 2D image plane determined based on the 3D virtual camera pose to generate a virtual 2D image of the target organ in a perspective corresponding to the 3D virtual camera pose,
obtaining 2D features of the virtual 2D image, and
creating a pair representing a mapping from the 2D features to the 3D virtual camera pose;
obtaining a 2D feature-camera pose mapping model based on the pairs of 2D features and the plurality of 3D virtual camera poses; and
a camera pose estimator implemented by a processor and configured for
obtaining a 3D pose estimate of a laparoscopic camera by mapping, via the 2D feature-camera pose mapping model, input 2D features extracted from a real-time 2D image of the target organ acquired by the laparoscopic camera to the 3D camera estimate, and
refining the 3D pose estimate to derive an estimated 3D camera pose of the laparoscopic camera via differential rendering of the 3D model with respect to the 3D pose estimate.

16. The system of claim 15, wherein the 2D features include one or more of:
intensity features characterizing the appearance of the 3D model when projected to the 2D image plane; and
geometric features characterizing the shape of the projected 3D model in the 2D image plane.

17. The system of claim 16, wherein the step of obtaining 2D features comprises:
processing the 2D image to obtain a segmentation of the target organ;
computing the intensity features within the segmentation; and
determining the geometric features of the target organ based on the segmentation.

18. The system of claim 15, wherein the step of obtaining the 2D feature-camera pose mapping model comprises:
constructing a look-up table (LUT) based on the pairs, wherein the LUT represents relationships between 2D features extracted from 2D images and 3D camera poses.

19. The system of claim 15, wherein the step of obtaining the 2D feature-camera pose mapping model comprises:
generating training data based on the pairs; and
obtaining, via machine learning, the 2D feature-camera pose mapping model capable of mapping input 2D features to a 3D camera pose.

20. The system of claim 15, wherein the input 2D features are obtained by:
acquiring, during a surgery via the laparoscopic camera positioned at a 3D camera pose, the real time 2D image of the target organ;
processing the real time 2D image to generate a segmentation of the target organ;
extracting input 2D features of the target organ as it appears in the real time 2D image.

21. The system of claim 15, wherein the step of refining the 3D pose estimate by:
generating a perturbed 3D camera pose based on the 3D pose estimate;
creating a differential rendering of the 3D model based on the perturbed 3D camera pose;
computing a loss based on the discrepancy between the real time 2D image and the differential rendering;
outputting the perturbed 3D camera pose as the estimated 3D camera pose of the laparoscopic camera, if the loss satisfies a convergence condition; and
repeating the steps of generating, creating, computing, and outputting until the perturbed 3D camera pose yields a differential rendering that satisfies the convergence condition.
